(19) United States
(12) Patent Application Publication
(10) Pub. No.: US 2010/0022475 A1
(43) Pub. Date: Jan. 28, 2010

(54) NOVEL TRIAZOLOPYRIMIDINE DERIVATIVES

(75) Inventors: Kurt Nebel, Basel (CH); Sebastian Volker Wendeborn, Basel (CH); Clemens Lamberth, Basel (CH); Patrick Jelf Crowley, Bracknell (GB); Fredrik Cederbaum, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignees: SYNGENTA CROP PROTECTION, INC., Greensboro, NC (US); SYNGENTA LIMITED, Guildford, Surrey (GB)

(21) Appl. No.: 11/722,232

(22) PCT Filed: Dec. 20, 2005
(86) PCT No.: PCT/EP2005/013709

§ 371 Date: Jun. 20, 2007

(30) Foreign Application Priority Data
Dec. 22, 2004 (EP) 04030434.7

(51) Int. Cl. A01N 55/10; C07F 7/10; A01P 3/00

(52) U.S. Cl. 514/63; 544/229

(57) ABSTRACT

The present invention relates to novel triazolopyrimidine derivatives of formula I as active ingredients which have microbiocidal activity, in particular fungicidal activity(I): wherein the substituents are as defined in claim 1. Characterizing feature is the cyclic silyl group.

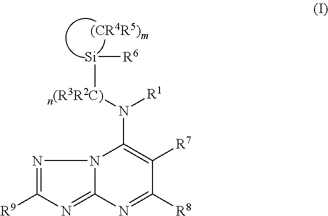

The present invention relates to novel triazolopyrimidine derivatives as active ingredients which have microbiocidal activity, in particular fungicidal activity. The invention also relates to preparation of these active ingredients, to novel heterocyclic derivatives used as intermediates in the preparation of these active ingredients, to preparation of these novel intermediates, to agrochemical compositions which comprise at least one of the novel active ingredients, to preparation of these compositions and to use of the active ingredients or compositions in agriculture or horticulture for controlling or preventing infestation of plants or non-living materials by phytopathogenic microorganisms, preferably fungi.

The present invention provides a compound of formula (1):

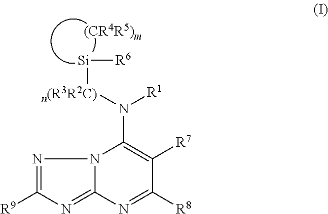

R¹ is hydrogen, C₁-C₆alkyl, C₁-C₆haloalkyl, C₂-C₆alkenyl, C₂-C₆alkynyl or C(═O)C₁-C₆alkyl;
R² and R³, each independently of each other and independently of n when n is 2, 3 or 4, are hydrogen, halogen, C₁-C₆alkyl, C₁-C₆haloalkyl or C₁-C₆alkyloxy, or
R² and R³ are part of a C═C double bond when n is 2, 3 or 4, or
R² and R³, together with the carbon atom to which they are attached, form an optionally substituted three- to six-membered ring;
R⁴ and R⁵, each independently of each other and independently of m, are hydrogen, halogen, C₁-C₆alkyl, C₁-C₆haloalkyl or C₁-C₆alkyloxy, or
R⁴ and R⁵, together with the carbon atom to which they are attached, form a group C═O, C═S or C═CR¹⁰R¹¹, or
R⁴ and R⁵, together with the carbon atom to which they are attached, form an optionally substituted three- to six-membered spiro-attached ring, or
R⁴ and R⁵ are part of an endocyclic C═C double bond, or
R⁴ and R⁵, together with the carbon atoms to which they are attached, form an optionally substituted saturated or unsaturated annulated five- to eight-membered ring;
R⁶ is C₁-C₆alkyl, C₁-C₆haloalkyl, C₃-C₆cycloalkyl, C₂-C₆alkenyl, C₂-C₆alkynyl, halogen, cyano, hydroxy or C₁-C₆alkyloxy;
R⁷ is optional substituted aryl or heteroaryl;
R⁸ is C₁-C₆alkyl, halogen or cyano;
R⁹ is hydrogen, mercapto or C₁-C₃alkylthio;
R¹⁰ and R¹¹, each independently of each other, are hydrogen, halogen, C₁-C₆alkyl, C₁-C₃haloalkyl or C₁-C₆alkyloxy;
m is 3, 4, 5, or 6;
n is 1, 2, 3 or 4.

In the instance where n is 2, 3 or 4, which means that 2, 3 or 4 contiguous carbon atoms respectively are present between the nitrogen atom substituted by R¹ and the silicon atom, the R² and R³ substituents on those carbon atoms can be the same or different substituents each independently of each other. For example, when n is 2, the first carbon atom can be substituted by R² as ethyl and R³ as bromine, and the second carbon atom can be substituted R² as methyl and R³ as methyloxy. The same situation could happen to (R⁴R⁵C)ₘ when m is 3, 4, 5 or 6, for R⁴ and R⁵, respectively.

When R² and R³ form an optionally substituted three- to six-membered ring together with the carbon atom to which they are attached; this ring is necessarily linked to the same carbon atom when n is 1, and can be linked to the same carbon atom or to another carbon atom when n is 2, 3 or 4.

When R⁴ and R⁵ form an optionally substituted saturated or unsaturated annulated five- to eight-membered ring together with the carbon atom to which they are attached; this annulated ring is necessarily linked to two different carbon atoms.

In the above definition aryl includes aromatic hydrocarbon rings like phenyl, naphthyl, anthracenyl, phenanthrenyl and biphenyl, with phenyl being preferred.

Heteroaryl stands for aromatic ring systems comprising mono-, bi- or tricyclic systems wherein at least one oxygen, nitrogen or sulfur atom is present as a ring member. Examples are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridiyl, pyridazinyl, pyrimidinyl, pyrazinyl, triazinyl, tetrazinyl, indolyl, benzothiophenyl, benzofuranyl, benzimidazolyl, indazolyl, benzotriazolyl, benzothiazolyl, benzoxazolyl, quinolinyl, isoquinolinyl, phthalazinyl, quinoxalinyl, quinazolinyl, cinnolinyl and naphthyridinyl. Each heteroaryl can be linked by a carbon atom or by a nitrogen atom to the [1,2,4]triazolo[1,5-a]pyrimidine.

The above aryl and heteroaryl groups may be optionally substituted. This means that they may carry one or more identical or different substituents. Normally not more than three substituents are present at the same time. Examples of substituents of aryl or heteroaryl groups are: halogen, alkyl, haloalkyl, cycloalkyl, cycloalkylalkyl, alkenyl, haloalkenyl, cycloalkenyl, alkynyl, haloalkynyl, alkyloxy, haloalkyloxy, cycloalkoxy, alkenyloxy, haloalkenyloxy, alkynyloxy, haloalkenyloxy, alkylthio, haloalkylthio, cycloalkylthio, alkenylthio, alkynylthio, alkylcarbonyl, haloalkylcarbonyl, cycloalkylcarbonyl, alkenylcarbonyl, alkynylcarbonyl, alkoxyalkyl, cyano, nitro, hydroxy, mercapto, amino, alkylamino, dialkylamino. Typical examples include phenyl, 2-fluorophenyl, 2-chlorophenyl, 2-trifluoromethylphenyl, 2-methylphenyl, 2,3-difluorophenyl, 2,4-difluorophenyl, 2,5-difluorophenyl, 2,6-difluorophenyl, 2,3-dichlorophenyl, 2,4-dichlorophenyl, 2,5-dichlorophenyl, 2,6-dichlorophenyl, 2-chloro-3-fluorophenyl, 2-chloro-4-fluorophenyl, 2-chloro-5-fluorophenyl, 2-chloro-6-fluorophenyl, 3-chloro-2-fluorophenyl, 4-chloro-2-fluorophenyl, 5-chloro-2-fluorophenyl, 2-fluoro-3-trifluoromethylphenyl, 2-fluoro-4-trifluoromethylphenyl, 2-fluoro-5-trifluoromethylphenyl, 2-fluoro-6-trifluoromethylphenyl, 2-chloro-3-trifluoromethylphenyl, 2-chloro-4-trifluoromethylphenyl, 2-chloro-5-trifluoromethylphenyl, 2-chloro-6-trifluoromethylphenyl, 4-fluoro-2-trifluoromethylphenyl, 4-chloro-2-trifluoromethylphenyl, 2-fluoro-3-methylphenyl, 2-fluoro-4-methylphenyl, 2-fluoro-5-methylphenyl, 2-fluoro-6-methylphenyl, 2-chloro-3-methylphenyl, 2-chloro-4-methylphenyl, 2-chloro-5-methylphenyl, 2-chloro-6-methylphenyl, 4-fluoro-2-methylphenyl, 4-chloro-2-methylphenyl, 2,3,4-trifluorophenyl, 2,3,6-trifluorophenyl, 2,4,6-trifluorophenyl, 2,3,4-trichlorophenyl, 2,3,6-trichlorophenyl, 2,4,6-trichlorophenyl, 2,6-difluoro-4-methoxyphenyl, 2,6-difluoro-4-trifluoromethoxyphenyl, 2,6-difluoro-4-trifluoromethylphenyl, 2,6-difluoro-4-cyanophenyl, 2,6-difluoro-4-methylphenyl, 2,6-dichloro-4-methoxyphenyl, 2,6-dichloro-4-trifluoromethoxyphenyl, 2,6-dichloro-4-trifluoromethylphenyl, 2,6-dichloro-4-cyanophenyl, 2,6-dichloro-4-methylphenyl, pentafluorophenyl, 3,5-difluoropyridin-2-yl, 3,5-dichloropyridin-2-yl, 3-chloro-5-fluoropyridine-2-yl, 5-chloro-3-fluoropyridin-2-yl, 3-fluoro-5-trifluoromethylpyridin-2-yl, 3-chloro-5-trifluoromethylpyridin-2-yl, 2,4-difluoropyridin-3-yl, 2,4-dichloropyridin-3-yl, 2,4,6-trifluoropyridin-3-yl, 2,4,6-trichloropyridin-3-yl, 3,5-difluoropyridin-4-yl, 3,5-dichloropyridin-4-yl, 2,5-difluorothiophen-3-yl and 2,5-dichlorothiophen-3-yl.

In the above definition, R⁴ and R⁵ can form an optionally substituted three- to six-membered spiro-attached ring together with the carbon atom to which they are attached. Typical examples of three- to six-membered attached ring include cyclopropyl, cyclobutyl, cyclopentyl, cyclohexyl, oxiranyl, aziridinyl, oxetanyl, azetidinyl, tetrahydrofuranyl, pyrrolidinyl, 1,3-dioxolanyl, 1,3-dioxanyl and 1,4-dioxanyl.

The above-defined three- to six-membered attached rings may be optionally substituted. This means that they may carry one or more identical or different substituents. Normally not more than three substituents are present at the same time. Typical examples of substituents of spiro-attached ring include hydrogen, halogen, C₁-C₆alkyl, C₁-C₆haloalkyl, C₁-C₆cycloalkyl and cyano.

In the above definition, R⁴ and R⁵ can form an optionally substituted saturated or unsaturated annulated ring together with the carbon atoms to which they are attached. Typical examples of the annulated ring include cyclopentane, cyclohexane, cycloheptane or benzene.

The above-defined annulated rings may be optionally substituted. This means that they may carry one or more identical or different substituents. Normally not more than 3 substituents are present at the same time. Typical examples of substituents of annulated ring include hydrogen, halogen, C₁-C₆alkyl, C₁-C₆haloalkyl, C₁-C₆cycloalkyl and cyano.

In the above definition halogen is fluorine, chlorine, bromine or iodine.

The alkyl, alkenyl or alkynyl radicals may be straight-chained or branched.

Alkyl on its own or as part of another substituent is, depending upon the number of carbon atoms mentioned, for example, methyl, ethyl, propyl, butyl, pentyl, hexyl and the isomers thereof, for example, isopropyl, isobutyl, sec-butyl, tert-butyl, isopentyl or tert-pentyl.

A haloalkyl group may contain one or more identical or different halogen atoms and for example may stand for CH₂Cl, CHCl₂, CCl₃, CH₂F, CHF₂, CF₃, CF₃CH₂, CH₃CF₂, CF₃CF₂, CCl₃CCl₂, etc.

Cycloalkyl on its own or as part of another substituent is, depending upon the number of carbon atoms mentioned, for example, cyclopropyl, cyclobutyl, cyclopentyl or cyclohexyl.

Alkenyl on its own or as part of another substituent is, depending upon the number of carbon atoms mentioned, for example, ethenyl, allyl, 1-propenyl, buten-2-yl, buten-3-yl, penten-1-yl, penten-3-yl, hexen-1-yl or-4-methyl-3-pentenyl.

Alkynyl on its own or as part of another substituent is, depending upon the number of carbon atoms mentioned, for example, ethynyl, propyn-1-yl, propyn-2-yl, butyn-1-yl, butyn-2-yl, 1-methyl-2-butynyl, hexyn-1-yl or 1-ethyl-2-butynyl.

The presence of one or more possible asymmetric carbon atoms in the compounds of formula I means that the compounds may occur in optically isomeric, that means enantiomeric or diastereomeric forms. As a result of the presence of a possible aliphatic C═C double bond, geometric isomerism, that means cis-trans or (E)-(Z) isomerism may also occur. Also atropisomers may occur as a result of restricted rotation about a single bond. Formula I is intended to include all those possible isomeric forms and mixtures thereof.

In each case, the compounds of formula I according to the invention are in free form or in an agronomically usable salt form.

Preferred subgroups of compounds of formula I are those wherein
R¹ is hydrogen, C₁-C₆alkyl, C₂-C₆alkenyl, C₂-C₆alkynyl or C(═O)C₁-C₆alkyl;
R² and R³, each independently of each other and independently of n when n is 2, 3 or 4, are hydrogen, halogen, C₁-C₆alkyl, C₁-C₆haloalkyl or C₁-C₆alkyloxy;
R⁴ and R⁵, each independently of each other, are hydrogen, halogen, C₁-C₆alkyl, C₁-C₆haloalkyl or C₁-C₆alkyloxy;
R⁶ is C₁-C₆alkyl, C₁-C₆haloalkyl, C₃-C₆cycloalkyl, C₂-C₆alkenyl, C₂-C₆alkynyl, halogen, hydroxy or C₁-C₆alkyloxy;
R⁷ is an optionally substituted aryl or heteroaryl;
R⁸ is C₁-C₆alkyl, halogen or cyano;
R⁹ is hydrogen, mercapto or C₁-C₃alkylthio;
m is 3, 4, 5, or 6;
n is 1, 2, 3 or 4.

More preferred subgroups of compounds of formula I are those wherein
R¹ is hydrogen, C₂-C₆alkenyl or C₂-C₆alkynyl;
R² and R³, each independently of each other and independently of n when n is 2, 3 or 4, are hydrogen, halogen, C₁-C₆alkyl or C₁-C₆haloalkyl;
R⁴ and R⁵, each independently of each other, are hydrogen, halogen or C₁-C₆alkyl;
R⁶ is C₁-C₆alkyl, C₁-C₆haloalkyl or C₃-C₆cycloalkyl;
R⁷ is an optionally substituted aryl;
R⁸ is C₁-C₃alkyl or halogen;
R⁹ is hydrogen, mercapto or methylthio;
m is 3, 4 or 5;
n is 1, 2 or 3

Most preferred subgroups of compounds of formula I are those wherein
R¹ is hydrogen or C₂-C₄alkynyl;
R² and R³, each independently of each other and independently of n when n is 2, 3 or 4, are hydrogen, C₁-C₃alkyl or C₁-C₃haloalkyl;
R⁴ and R⁵, each independently of each other, are hydrogen or C₁-C₃alkyl;
R⁶ is C₁-C₃alkyl or C₁-C₃haloalkyl;
R⁷ is phenyl substituted at least in one orthoposition with halogen;
R⁸ is chloro or fluoro;
R⁹ is hydrogen or mercapto;
m is 4 or 5;
n is 1 or 2.

Especially preferred subgroups of compounds of formula I are those wherein
R¹ is hydrogen;
R² and R³, each independently of each other and independently of n when n is 2, 3 or 4, are hydrogen, methyl or trifluoromethyl;
R⁴ and R⁵, each independently of each other, are hydrogen or methyl;
R⁶ is methyl or ethyl;
R⁷ is 2,4,6-trifluorophenyl or 2-chloro-6-fluorophenyl;
R⁸ is chloro;
R⁹ is hydrogen;
m is 4 or 5;
n is 1.
   Preferred individual compounds are:

[5-chloro-6-(2,4,6-trifluoro-phenyl)-[1,2,4]triazolo[1,5-a]pyrimidin-7-yl]-(1-methyl-silolan-1-ylmethyl)-amine (Compound No.I.d.081),

[5-chloro-6-(2-chloro-6-fluoro-phenyl)-[1,2,4]triazolo[1,5-a]pyrimidin-7-yl]-(1-methyl-silolan-1-ylmethyl)-amine (Compound No.I.d.031),
[5-chloro-6-(2,4,6-trifluoro-phenyl)-[1,2,4]triazolo[1,5-a]pyrimidin-7-yl]-[2,2,2-trifluoro-1-(1-methyl-silolan-1-yl)-ethyl]-amine (Compound No.I.g.081),
[5-chloro-6-(2-chloro-6-fluoro-phenyl)-[1,2,4]triazolo[1,5-a]pyrimidin-7-yl]-[2,2,2-trifluoro-1-(1-methyl-silolan-1-yl)-ethyl]-amine (Compound No.I.g.031),
[5-chloro-6-(2,4,6-trifluoro-phenyl)-[1,2,4]triazolo[1,5-a]pyrimidin-7-yl]-(1-methyl-2,5-dihydro-1H-silol-1-ylmethyl)-amine (Compound No.I.I.081),
[5-chloro-6-(2-chloro-6-fluoro-phenyl)-[1,2,4]triazolo[1,5-a]pyrimidin-7-yl]-(1-methyl-2,5-dihydro-1H-silol-1-ylmethyl)-amine (Compound No.I.I.031),
[5-chloro-6-(2,4,6-trifluoro-phenyl)-[1,2,4]triazolo[1,5-a]pyrimidin-7-yl]-(1-methyl-silinan-1-ylmethyl)-amine (Compound No.I.o.081),
[5-chloro-6-(2-chloro-6-fluoro-phenyl)-[1,2,4]triazolo[1,5-a]pyrimidin-7-yl]-(1-methyl-silinan-1-ylmethyl)-amine (Compound No.I.o.031),
[5-chloro-6-(2,4,6-trifluoro-phenyl)-[1,2,4]triazolo[1,5-a]pyrimidin-7-yl]-[1-(1-methyl-silinan-1-yl)-ethyl]-amine (Compound No.I.r.081),
[5-chloro-6-(2-chloro-6-fluoro-phenyl)-[1,2,4]triazolo[1,5-a]pyrimidin-7-yl]-[1-(1-methyl-silinan-1-yl)-ethyl]-amine (Compound No.I.r.031),
[5-chloro-6-(2,4,6-trifluoro-phenyl)-[1,2,4]triazolo[1,5-a]pyrimidin-7-yl]-[2,2,2-trifluoro-1-(1-methyl-silinan-1-yl)-ethyl]-amine (Compound No.I.s.081),
[5-chloro-6-(2-chloro-6-fluoro-phenyl)-[1,2,4]triazolo[1,5-a]pyrimidin-7-yl]-[2,2,2-trifluoro-1-(1-methyl-silinan-1-yl)-ethyl]-amine (Compound No.I.s.031).

Certain triazolo[1,5-a]pyrimidine derivatives with trialkylsilyl-containing amines in position 7 have been proposed for controlling plant-destructive fungi, for example in WO 98/46607, U.S. Pat. No. 6,117,876 and U.S. Pat. No. 6,297,251. However, the action of those preparations is not satisfactory in all aspects of agricultural needs. Surprisingly, with the compounds of formula I, new kinds of fungicides having a high level of biological actitivity have now been found.

The compounds of formula I can be obtained by coupling of a compound of formula II, wherein R⁷, R⁸ and R⁹ are as defined for formula I and Hal is halogen, preferably fluorine, chlorine or bromine, with a compound of formula III, wherein R¹, R², R³, R⁴, R⁵, R⁶, m and n are as defined for formula I.

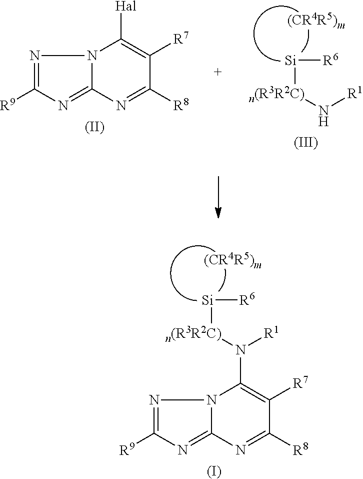

The reaction (II+III→I) can be carried out in a manner known per se for the transformation of amines with heterocyclic halides, e.g. 4-halopyrimidines or 7-halotriazolo[1,5-a]pyrimidines. Preferably the reaction is carried out in solution. Preferred are either organic solvents like N,N-dimethylformamide, N,N-dimethylacetamide, acetonitrile, dioxane, N-methylpyrrolidon, methanol, ethanol or dimethylsulfoxide, or organic solvents, like toluene or xylene in mixture with water and a phase transfer catalyst. The reaction is advantageously carried out in the presence of a base. In general all types of organic or inorganic bases may be used, for instance triethylamine, diisopropylethylamine, pyridine, 4-dimethylaminopyridine, sodium hydroxide, potassium hydroxide, sodium methoxide, sodium ethoxide, sodium carbonate or potassium carbonate. Reaction temperatures are between 0° C. and +100° C., preferably between +10° C. and +50° C. The reaction of trialkylsilyl-containing amines with compounds of formula II is already described in WO 98/46607, U.S. Pat. No. 6,117,876 and U.S. Pat. No. 6,297,251.

The compounds of formula II, wherein R⁷, R⁸ and R⁹ are as defined for formula I and Hal is halogen, preferably fluorine, chlorine or bromine, can be obtained by halogenation of a compound of formula IV, wherein R⁷ and R⁹ are as defined for formula I and R¹² is hydroxy, C₁-C₆alkyl or cyano.

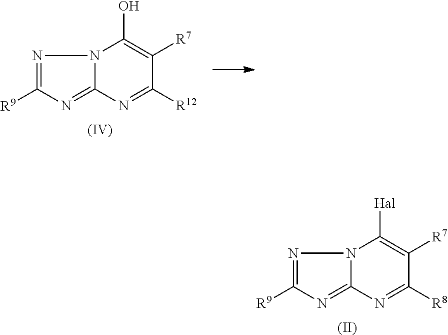

The preparation of compounds of formula II is already described in WO 2002/038565, U.S. Pat. No. 6,297,251 and U.S. Pat. No. 6,117,876.

The compounds of formula III, wherein R¹, R², R³, R⁴, R⁵, R⁶, m and n are as defined for formula I, can be obtained by known methods for the synthesis of silacycle-containing amines.

For instance, the synthesis of C-(silolan-1-yl)methylamines and C-(silinan-1-yl)methylamines of formula (IIIa) can be achieved from □-dibromoalkanes of formula (V).

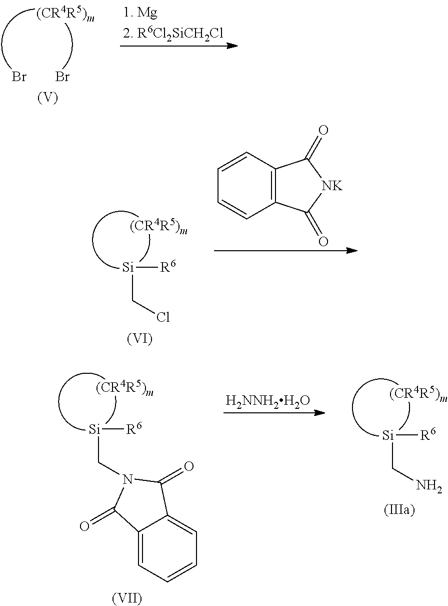

Surprisingly, it has now been found that the novel compounds of formula I have, for practical purposes, a very advantageous spectrum of activities for protecting plants against diseases that are caused by fungi as well as by bacteria and viruses.

The compounds of formula I can be used in the agricultural sector and related fields of use as active ingredients for controlling plant pests or on non-living materials for control of spoilage microorganisms or organisms potentially harmfull to man. The novel compounds are distinguished by excellent activity at low rates of application, by being well tolerated by plants and by being environmentally safe. They have very useful curative, preventive and systemic properties and are used for protecting numerous cultivated plants. The compounds of formula I can be used to inhibit or destroy the pests that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula I as dressing agents for the treatment of plant propagation material, e.g., seed, such as fruits, tubers or grains, or plant cuttings (for example rice), for the protection against fungal infections as well as against phytopathogenic fungi occurring in the soil. The propagation material can be treated with a composition comprising a compound of formula I before planting: seed, for example, can be dressed before being sown. The active ingredients according to the invention can also be applied to grains (coating), either by impregnating the seeds in a liquid formulation or by coating them with a solid formulation. The composition can also be applied to the planting site when the propagation material is being planted, for example, to the seed furrow during sowing. The invention relates also to such methods of treating plant propagation material and to the plant propagation material so treated.

Furthermore the compounds according to present invention can be used for controlling fungi in related areas, for example in the protection of technical materials, including wood and wood related technical products, in food storage, in hygiene management.

In addition, the invention could be used to protect non-living materials from fungal attack, e.g. lumber, wall boards and paint.

The compounds of formula I are, for example, effective against the phytopathogenic fungi of the following classes: Fungi imperfecti (e.g. Botrytis spp., Alternaria spp.) and Basidiomycetes (e.g. Rhizoctonia spp., Hemileia spp., Puccinia spp., Phakopsora spp.). Additionally, they are also effective against Ascomycetes (e.g. Venturia spp., Blumeria spp., Podosphaera leucotricha, Monilinia spp., Fusarium spp., Uncinula spp., Mycosphaerella spp. Pyrenophora spp., Rhynchosporium secalis, Magnaporthe spp., Colletotrichum spp.) and Oomycetes (e.g. Phytophthora spp., Pythium spp., Plasmopara spp.). Outstanding activity has been observed against powdery mildews (e.g. Uncinula necator), rusts (e.g. Puccinia spp.) and leaf spots (e.g. Septoria tritici). Furthermore, the novel compounds of formula I are effective against phytopathogenic bacteria and viruses (e.g. against Xanthomonas spp, Pseudomonas spp, Erwinia amylovora as well as against the tobacco mosaic virus).

Within the scope of present invention, target crops to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as turf and ornamentals.

The target crops in accordance with the invention include conventional as well as genetically enhanced or engineered varieties such as, for example, insect resistant (e.g. Bt. And VIP varieties) as well as disease resistant, herbicide tolerant (e.g. glyphosate- and glufosinate-resistant maize varieties commercially available under the trade names RoundupReady® and LibertyLink®) and nematode tolerant varieties. By way of example, suitable genetically enhanced or engineered crop varieties include the Stoneville 5599BR cotton and Stoneville 4892BR cotton varieties.

The compounds of formula I are used in unmodified form or, preferably, together with the adjuvants conventionally employed in the art of formulation. To this end they are conveniently formulated in known manner to emulsifiable concentrates, coatable pastes, directly sprayable or dilutable solutions or suspensions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds. of formula I are normally used in the form of compositions and can be applied to the crop area or plant to be treated, simultaneously or in succession with further compounds. These further compounds can be e.g. fertilizers or micronutrient donors or other preparations, which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

The compounds of formula I are normally used in the form of fungicidal compositions for controlling and protecting against phytopathogenic microorganisms, comprising as active ingredient at least one compound of formula I, in free form or in agrochemically usable salt form, and at least one of the above-mentioned adjuvants.

The compounds of formula I can be mixed with other fungicides, resulting in some cases in unexpected synergistic activities (claim 10). Mixing components which are particularly preferred are:

Azoles, such as azaconazole, BAY 14120, bitertanol, bromuconazole, cyproconazole, difenoconazole, diniconazole, epoxiconazole, fenbuconazole, fluquinconazole, flusilazole, flutriafol, hexaconazole, imazalil, imibenconazole, ipconazole, metconazole, myclobutanil, pefurazoate, penconazole, prothioconazole, pyrifenox, prochloraz, propiconazole, simeconazole, tebuconazole, tetraconazole, triadimefon, triadimenol, triflumizole, triticonazole;

Pyrimidinyl carbinole, such as ancymidol, fenarimol, nuarimol;

2-amino-pyrimidines, such as bupirimate, dimethirimol, ethirimol;

Morpholines, such as dodemorph, fenpropidine, fenpropimorph, spiroxamine, tridemorph;

Anilinopyrimidines, such as cyprodinil, mepanipyrim, pyrimethanil;

Pyrroles, such as fenpiclonil, fludioxonil;

Phenylamides, such as benalaxyl, furalaxyl, metalaxyl, R-metalaxyl, ofurace, oxadixyl;

Benzimidazoles, such as benomyl, carbendazim, debacarb, fuberidazole, thiabendazole;

Dicarboximides, such as chlozolinate, dichlozoline, iprodione, myclozoline, procymidone, vinclozoline;

Carboxamides, such as boscalid, carboxin, fenfuram, flutolanil, mepronil, oxycarboxin, penthiopyrad, thifluzamide; guanidines, such as guazatine, dodine, iminoctadine;

Strobilurines, such as azoxystrobin, dimoxystrobin (SSF 129), enestroburin, fluoxastrobin, kresoxim-methyl, metominostrobin, trifloxystrobin, orysastrobin, picoxystrobin, pyraclostrobin;

Dithiocarbamates, such as ferbam, mancozeb, maneb, metiram, propineb, thiram, zineb, ziram;

N-halomethylthiotetrahydrophthalimides, such as captafol, captan, dichlofluanid, fluoromides, folpet, tolyfluanid;

Cu-compounds, such as Bordeaux mixture, copper hydroxide, copper oxychloride, copper sulfate, cuprous oxide, mancopper, oxine-copper;

Nitrophenol-derivatives, such as dinocap, nitrothal-isopropyl;

Organo-p-derivatives, such as edifenphos, iprobenphos, isoprothiolane, phosdiphen, pyrazophos, toiclofos-methyl;

Various others, such as acibenzolar-S-methyl, anilazine, benthiavalicarb, blasticidin-S, chinomethionate, chloroneb, chlorothalonil, cyflufenamid, cymoxanil, dichlone, diclocymet, diclomezine, dicloran, diethofencarb, dimethomorph, SYP-LI90 (proposed name: flumorph), dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, IKF-916 (cyazofamid), kasugamycin, methasulfocarb, metrafenone, nicobifen, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide (RH7281).

A method of controlling and preventing an infestation of crop plants or non-living materials by phytopathogenic or spoilage microorganisms or organisms potentially harmful to man, especially fungal organisms, which comprises the application of a compound of formula I as active ingredient to the plant, to parts of the plants or to the locus thereof, or to any part of the non-living materials.

A preferred method of controlling and preventing an infestation of crop plants by phytopathogenic microorganisms, especially fungal organisms, which comprises the application of a compound of formula I, or an agrochemical composition which contains at least one of said compounds, is foliar application. The frequency of application and the rate of application will depend on the risk of infestation by the corresponding pathogen. However, the compounds of formula I can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula I may also be applied to seeds (coating) by impregnating the seeds or tubers either with a liquid formulation of the fungicide or coating them with a solid formulation.

A formulation [that is, a composition containing the compound of formula I] and, if desired, a solid or liquid adjuvant or monomers for encapsulating the compound of formula I, is prepared in a known manner, typically by intimately mixing and/or grinding the compound with extenders, for example solvents, solid carriers and, optionally, surface active compounds (surfactants).

The agrochemical formulations will usually contain from 0.1 to 99% by weight, preferably from 0.1 to 95% by weight, of the compound of formula I, 99.9 to 1% by weight, preferably 99.8 to 5% by weight, of a solid or liquid adjuvant, and from 0 to 25% by weight, preferably from 0.1 to 25% by weight, of a surfactant.

Advantageous rates of application are normally from 5 g to 2 kg of active ingredient (a.i.) per hectare (ha), preferably from 10 g to 1 kg a.i/ha, most preferably from 20 g to 600 g a.i./ha. When used as seed drenching agent, convenient dosages are from 10 mg to 1 g of active substance per kg of seeds.

Whereas it is preferred to formulate commercial products as concentrates, the end user will normally use dilute formulations.

The following non-limiting Examples illustrate the above-described invention in more detail.

### EXAMPLE 1

### This example illustrates the preparation of [5-chloro-6-(2,4,6-trifluoro-phenyl)-[1,2,4]triazolo[1,5-a]pyrimidin-7-yl]-(1-methyl-silolan-1-ylmethyl)-amine (Compound No.I.d.081)

### a) Preparation of 1-chloromethyl-1-methyl-silolane

A solution of 1,4-dibromobutane (13 g, 60 mmol) in 30 ml of tetrahydrofuran is added dropwise to a suspension of magnesium (6.5 g, 0.27 mol) in 120 ml of tetrahydrofuran. After the addition of the first 5 ml of the 1,4-dibromobutane solution, the exothermic transformation is started by addition of catalytic amounts of iodine. When all of the 1,4-dibromobutane is added, the reaction mixture is stirred for 8 h at room temperature. Subsequently, dichloro-chloromethyl-methylsilane (8.2 g, 50 mmol) is added dropwise and the resulting mixture is heated to reflux for 16 h. The reaction is poured on ice/water and extracted with tert-butyl methyl ether. The combined organic layer is washed with brine, dried over magnesium sulfate and evaporated to yield 7.8 g of 1-chloromethyl-1-methyl-silolane, which can be directly used in the next step without further purification.

### b) Preparation of 2-(1-methyl-silolan-1-ylmethyl)-isoindole-1,3-dione

A solution of 1 chloromethyl-1-methyl-silolane (7.4 g, 50 mmol) and phthalimide potassium salt (9.3 g, 50 mmol) in 150 ml of N,N-dimethylformamide is stirred overnight at 80° C. Subsequently the reaction mixture is cooled to room temperature, poured on water and extracted with tert-butyl methyl ether. The combined organic layer is washed with brine, dried over magnesium sulfate and evaporated. The residue is purified by chromatography on silica gel, using ethyl acetate and hexane as eluents, to deliver 10 g of 2-(1-methyl-silolan-1-ylmethyl)-isoindole-1,3-dione.

### c) Preparation of C-(1-methyl-silolan-1-yl)-methylamine hydrochloride

A solution of 2-(1-methyl-silolan-1-ylmethyl)-isoindole-1,3-dione (9.8 g, 38 mmol) and hydrazine hydrate (2.1 g, 42 mmol) in 75 ml of ethanol is heated to reflux for 16 h. Subsequently the mixture is cooled to room temperature and concentrated in vacuo. 75 ml of ethanol and 60 ml of 2 N hydrochloric acid are added to the residue, and the resulting mixture is heated to reflux for 6 h. After cooling to room temperature, the solvent is removed in vacuo and the remainder is taken up with cold water to yield 5.5 g of C-(1-methyl-silolan-1-yl)-methylamine hydrochloride as colourless cristalls.

d) C-(1-methyl-silolan-1-yl)-methylamine hydrochloride (0.2 g, 1.3 mmol) and triethylamine (0.27 g, 2.7 mmol) are added consecutively to a solution of 5,7-dichloro-6-(2,4,6)-trifluoro-phenyl)-[1,2,4]triazolo[1,5-a]pyrimidine (0.4 g, 1.25 mmol) in 4 ml of dichloromethane. This mixture is stirred 16 h at room temperature, then poured on icewater and extracted with diethyl ether. The combined organic layer is washed with water, dried over magnesium sulfate and evaporated. The residue is purified by chromatography on silica gel, using ethyl aceate and hexane as eluents, to deliver 0.3 g of [5-chloro-6-(2,4,6-trifluoro-phenyl)-[1,2,4]triazolo[1,5-a]pyrimidin-7-yl]-(1-methyl-silolan-1-ylmethyl)-amine (Compound No.I.d.081).

### EXAMPLE 2

### This example illustrates the preparation of [5-chloro-6-(2,4,6-trifluoro-phenyl)-[1,2,4]triazolo[1,5-a]pyrimidin-7-yl]-(1-methyl-silinan-1-ylmethyl)-amine (Compound No.I.o.081)

### a) Preparation of 1-chloromethyl-1-methyl-silinane

A solution of 1,5-dibromopentane (11.5 g, 50 mmol) in 25 ml of tetrahydrofuran is added dropwise to a suspension of magnesium (6.0 g, 0.25 mol) in 100 ml of tetrahydrofuran. After the addition of the first 5 ml of the 1,4-dibromobutane solution, the exothermic transformation is started by addition of catalytic amounts of iodine. When all of the 1,4-dibromobutane is added, the reaction mixture is stirred for 8 h at room temperature. Subsequently, dichloro-chloromethyl-methylsilane (7.4 g, 45 mmol) is added dropwise and the resulting mixture is heated to reflux for 16 h. The reaction is poured on ice/water and extracted with tert-butyl methyl ether. The combined organic layer is washed with brine, dried over magnesium sulfate and evaporated to yield 8.0 g of 1-chloromethyl-1-methyl-silinane, which can be directly used in the next step without further purification.

### b) Preparation of 2-(1-methyl-silinan-1-ylmethyl)-isoindole-1,3-dione

A solution of 1-chloromethyl-1-methyl-silinane (7.3 g, 45 mmol) and phthalimide potassium salt (8.3 g, 45 mmol) in 125 ml of N,N-dimethylformamide is stirred overnight at 80° C. Subsequently the reaction mixture is cooled to room temperature, poured on water and extracted with tert-butyl methyl ether. The combined organic layer is washed with brine, dried over magnesium sulfate and evaporated. The residue is purified by chromatography on silica gel, using ethyl acetate and hexane as eluents, to deliver 7.5 g of 2-(1-methyl-silinan-1-ylmethyl)-isoindole-1,3-dione.

### c) Preparation of C-(1-methyl-silinan-1-yl)-methylamine hydrochloride

A solution of 2-(1-methyl-silinan-1-ylmethyl)-isoindole-1,3-dione (5.7 g, 20 mmol) and hydrazine hydrate (1.1 g, 22 mmol) in 40 ml of ethanol is heated to reflux for 16 h. Subsequently the mixture is cooled to room temperature and concentrated in vacuo. 40 ml of ethanol and 30 ml of 2 N hydrochloric acid are added to the residue, and the resulting mixture is heated to reflux for 6 h. After cooling to room temperature, the solvent is removed in vacuo and the remainder is taken up with cold water to yield 3.3 g of C-(1-methyl-silinan-1-yl)-methylamine hydrochloride as colourless cristalls.

d) C-(1-methyl-silinan-1-yl)-methylamine hydrochloride (0.23 g, 1.3 mmol) and triethylamine (0.32 g, 3.2 mmol) are added consecutively to a solution of 5,7-dichloro-6-(2,4,6)-trifluoro-phenyl)-[1,2,4]triazolo[1,5-a]pyrimidine (0.4 g, 1.25 mmol) in 4 ml of dichloromethane. This mixture is stirred 16 h at room temperature, then poured on icewater and extracted with diethyl ether. The combined organic layer is washed with water, dried over magnesium sulfate and evaporated. The residue is purified by chromatography on silica gel, using ethyl aceate and hexane as eluents, to deliver 0.3 g of [5-chloro-6-(2,4,6-trifluoro-phenyl)-[1,2,4]triazolo[1,5-a]pyrimidin-7-yl]-(1-methyl-silinan-1-ylmethyl)-amine (Compound No.I.o.081).

Table 1 below illustrates individual compounds of formula I according to the invention.

TABLE 1
individual compounds of formula I according to the invention

| Compound | | | |
|---|---|---|---|
| No. | R⁷ | R⁸ | R⁹ |
| 001 | 2-fluorophenyl | Cl | H |
| 002 | 2-fluorophenyl | F | H |
| 003 | 2-chlorophenyl | Cl | H |
| 004 | 2-chlorophenyl | F | H |
| 005 | 2-trifluoromethylphenyl | Cl | H |
| 006 | 2-trifluoromethylphenyl | F | H |
| 007 | 2-methylphenyl | Cl | H |
| 008 | 2-methylphenyl | F | H |
| 009 | 2,3-difluorophenyl | Cl | H |
| 010 | 2,3-difluorophenyl | F | H |
| 011 | 2,4-difluorophenyl | Cl | H |
| 012 | 2,4-difluorophenyl | F | H |
| 013 | 2,5-difluorophenyl | Cl | H |
| 014 | 2,5-difluorophenyl | F | H |
| 015 | 2,6-difluorophenyl | Cl | H |
| 016 | 2,6-difluorophenyl | F | H |
| 017 | 2,3-dichlorophenyl | Cl | H |
| 018 | 2,3-dichlorophenyl | F | H |
| 019 | 2,4-dichlorophenyl | Cl | H |
| 020 | 2,4-dichlorophenyl | F | H |
| 021 | 2,5-dichlorophenyl | Cl | H |
| 022 | 2,5-dichlorophenyl | F | H |
| 023 | 2,6-dichlorophenyl | Cl | H |
| 024 | 2,6-dichlorophenyl | F | H |
| 025 | 2-chloro-3-fluorophenyl | Cl | H |
| 026 | 2-chloro-3-fluorophenyl | F | H |
| 027 | 2-chloro-4-fluorophenyl | Cl | H |
| 028 | 2-chloro-4-fluorophenyl | F | H |
| 029 | 2-chloro-5-fluorophenyl | Cl | H |
| 030 | 2-chloro-5-fluorophenyl | F | H |
| 031 | 2-chloro-6-fluorophenyl | Cl | H |
| 032 | 2-chloro-6-fluorophenyl | Cl | SH |
| 033 | 2-chloro-6-fluorophenyl | F | H |
| 034 | 2-chloro-6-fluorophenyl | CH₃ | H |
| 035 | 3-chloro-2-fluorophenyl | Cl | H |
| 036 | 3-chloro-2-fluorophenyl | F | H |
| 037 | 4-chloro-2-fluorophenyl | Cl | H |
| 038 | 4-chloro-2-fluorophenyl | F | H |
| 039 | 5-chloro-2-fluorophenyl | Cl | H |
| 040 | 5-chloro-2-fluorophenyl | F | H |
| 041 | 2-fluoro-3-trifluoromethylphenyl | Cl | H |
| 042 | 2-fluoro-3-trifluoromethylphenyl | F | H |
| 043 | 2-fluoro-4-trifluoromethylphenyl | Cl | H |
| 044 | 2-fluoro-4-trifluoromethylphenyl | F | H |
| 045 | 2-fluoro-5-trifluoromethylphenyl | Cl | H |
| 046 | 2-fluoro-5-trifluoromethylphenyl | F | H |
| 047 | 2-fluoro-6-trifluoromethylphenyl | Cl | H |
| 048 | 2-fluoro-6-trifluoromethylphenyl | F | H |
| 049 | 2-chloro-3-trifluoromethylphenyl | Cl | H |
| 050 | 2-chloro-3-trifluoromethylphenyl | F | H |
| 051 | 2-chloro-4-trifluoromethylphenyl | Cl | H |
| 052 | 2-chloro-4-trifluoromethylphenyl | F | H |
| 053 | 2-chloro-5-trifluoromethylphenyl | Cl | H |
| 054 | 2-chloro-5-trifluoromethylphenyl | F | H |
| 055 | 2-chloro-6-trifluoromethylphenyl | Cl | H |
| 056 | 2-chloro-6-trifluoromethylphenyl | F | H |
| 057 | 4-fluoro-2-trifluoromethylphenyl | Cl | H |
| 058 | 4-fluoro-2-trifluoromethylphenyl | F | H |
| 059 | 4-chloro-2-trifluoromethylphenyl | Cl | H |
| 060 | 4-chloro-2-trifluoromethylphenyl | F | H |
| 061 | 2-fluoro-3-methylphenyl | Cl | H |
| 062 | 2-fluoro-3-methylphenyl | F | H |
| 063 | 2-fluoro-4-methylphenyl | Cl | H |
| 064 | 2-fluoro-4-methylphenyl | F | H |
| 065 | 2-fluoro-5-methylphenyl | Cl | H |
| 066 | 2-fluoro-5-methylphenyl | F | H |
| 067 | 2-fluoro-6-methylphenyl | Cl | H |
| 068 | 2-fluoro-6-methylphenyl | F | H |
| 069 | 2-chloro-3-methylphenyl | Cl | H |
| 070 | 2-chloro-3-methylphenyl | F | H |
| 071 | 2-chloro-4-methylphenyl | Cl | H |
| 072 | 2-chloro-4-methylphenyl | F | H |
| 073 | 2-chloro-5-methylphenyl | Cl | H |
| 074 | 2-chloro-5-methylphenyl | F | H |
| 075 | 2-chloro-6-methylphenyl | Cl | H |
| 076 | 2-chloro-6-methylphenyl | F | H |
| 077 | 4-fluoro-2-methylphenyl | Cl | H |
| 078 | 4-fluoro-2-methylphenyl | F | H |
| 079 | 4-chloro-2-methylphenyl | Cl | H |
| 080 | 4-chloro-2-methylphenyl | F | H |
| 081 | 2,4,6-trifluorophenyl | Cl | H |
| 082 | 2,4,6-trifluorophenyl | Cl | SH |
| 083 | 2,4,6-trifluorophenyl | F | H |
| 084 | 2,4,6-trifluorophenyl | CH₃ | H |
| 085 | 2,3,6-trifluorophenyl | Cl | H |
| 086 | 2,3,6-trifluorophenyl | F | H |
| 087 | 2,3,4-trifluorophenyl | Cl | H |
| 088 | 2,3,4-trifluorophenyl | F | H |
| 089 | 2,4,6-trichlorophenyl | Cl | H |
| 090 | 2,4,6-trichlorophenyl | F | H |
| 091 | 2,3,6-trichlorophenyl | Cl | H |
| 092 | 2,3,6-trichlorophenyl | F | H |
| 093 | 2,3,4-trichlorophenyl | Cl | H |
| 094 | 2,3,4-trichlorophenyl | F | H |
| 095 | 2,6-difluoro-4-methoxyphenyl | Cl | H |
| 096 | 2,6-difluoro-4-methoxyphenyl | F | H |
| 097 | 2,6-difluoro-4-trifluoromethoxyphenyl | Cl | H |
| 098 | 2,6-difluoro-4-trifluoromethoxyphenyl | F | H |
| 099 | 2,6-difluoro-4-trifluoromethylphenyl | Cl | H |
| 100 | 2,6-difluoro-4-trifluoromethylphenyl | F | H |
| 101 | 2,6-difluoro-4-cyanoyphenyl | Cl | H |
| 102 | 2,6-difluoro-4-cyanophenyl | F | H |
| 103 | 2,6-difluoro-4-methylphenyl | Cl | H |
| 104 | 2,6-difluoro-4-methylphenyl | F | H |
| 105 | 2,6-dichloro-4-methoxyphenyl | Cl | H |
| 106 | 2,6-dichloro-4-methoxyphenyl | F | H |
| 107 | 2,6-dichloro-4-trifluoromethoxyphenyl | Cl | H |
| 108 | 2,6-dichloro-4-trifluoromethoxyphenyl | F | H |
| 109 | 2,6-dichloro-4-trifluoromethylphenyl | Cl | H |
| 110 | 2,6-dichloro-4-trifluoromethylphenyl | F | H |
| 111 | 2,6-dichloro-4-cyanophenyl | Cl | H |
| 112 | 2,6-dichloro-4-cyanophenyl | F | H |
| 113 | 2,6-dichloro-4-methylphenyl | Cl | H |
| 114 | 2,6-dichloro-4-methylphenyl | F | H |
| 115 | pentafluorophenyl | Cl | H |
| 116 | pentafluorophenyl | F | H |
| 117 | 3,5-difluoropyridin-2-yl | Cl | H |
| 118 | 3,5-difluoropyridin-2-yl | F | H |
| 119 | 3,5-dichloropyridin-2-yl | Cl | H |
| 120 | 3,5-dichloropyridin-2-yl | F | H |
| 121 | 3-chloro-5-fluoropyridin-2-yl | Cl | H |
| 122 | 3-chloro-5-fluoropyridin-2-yl | F | H |
| 123 | 5-chloro-3-fluoropyridin-2-yl | Cl | H |
| 124 | 5-chloro-3-fluoropyridin-2-yl | F | H |
| 125 | 3-fluoro-5-trifluoromethylpyridin-2-yl | Cl | H |
| 126 | 3-fluoro-5-trifluoromethylpyridin-2-yl | F | H |
| 127 | 3-chloro-5-trifluoromethylpyridin-2-yl | Cl | H |
| 128 | 3-chloro-5-trifluoromethylpyridin-2-yl | F | H |
| 129 | 2,4-difluoropyridin-3-yl | Cl | H |
| 130 | 2,4-difluoropyridin-3-yl | F | H |
| 131 | 2,4-dichloropyridin-3-yl | Cl | H |
| 132 | 2,4-dichloropyridin-3-yl | F | H |
| 133 | 2,4,6-trifluoropyridin-3-yl | Cl | H |
| 134 | 2,4,6-trifluoropyridin-3-yl | F | H |
| 135 | 2,4,6-trichloropyridin-3-yl | Cl | H |
| 136 | 2,4,6-trichloropyridin-3-yl | F | H |
| 137 | 3,5-difluoropyridin-4-yl | Cl | H |
| 138 | 3,5-difluoropyridin-4-yl | F | H |
| 139 | 3,5-dichloropyridin-4-yl | Cl | H |
| 140 | 3,5-dichloropyridin-4-yl | F | H |
| 141 | 2,5-difluorothiophen-3-yl | Cl | H |
| 142 | 2,5-difluorothiophen-3-yl | F | H |
| 143 | 2,5-dichlorothiophen-3-yl | Cl | H |
| 144 | 2,5-dichlorothiophen-3-yl | F | H |

Table 1 provides 144 compounds of formula (I.a):

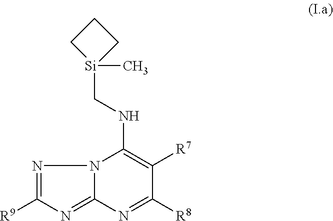

wherein R⁷, R⁸ and R⁹ are as defined in Table 1.

Table 1 provides 144 compounds of formula (I.b):

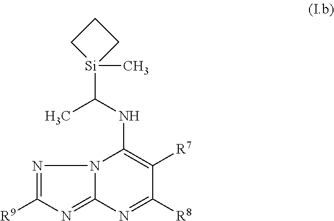

wherein R⁷, R⁸ and R⁹ are as defined in Table 1.

Table 1 provides 144 compounds of formula (I.c):

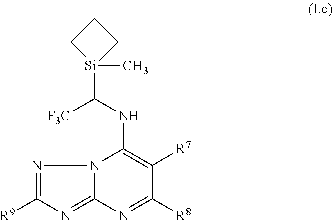

wherein R⁷, R⁸ and R⁹ are as defined in Table 1.

Table 1 provides 144 compounds of formula (I.d):

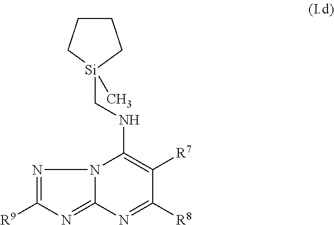

wherein R⁷, R⁸ and R⁹ are as defined in Table 1.

Table 1 provides 144 compounds of formula (I.e):

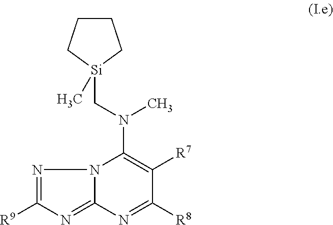

wherein R⁷, R⁸ and R⁹ are as defined in Table 1.

Table 1 provides 144 compounds of formula (I.f):

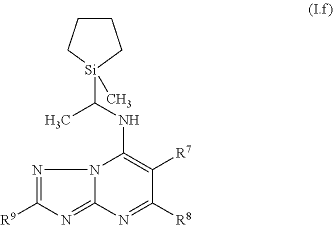

wherein R⁷, R⁸ and R⁹ are as defined in Table 1.

Table 1 provides 144 compounds of formula (I.g):

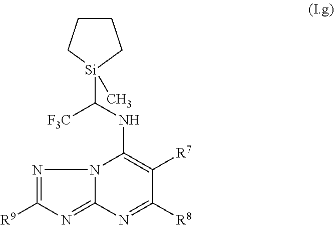

wherein R⁷, R⁸ and R⁹ are as defined in Table 1.

Table 1 provides 144 compounds of formula (I.h):

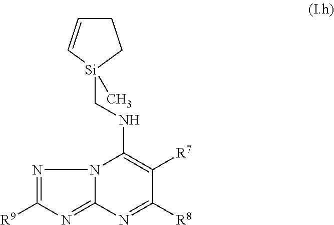

wherein R⁷, R⁸ and R⁹ are as defined in Table 1.

Table 1 provides 144 compounds of formula (I.i):

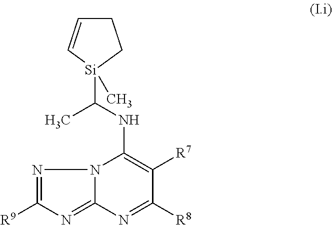

wherein R⁷, R⁸ and R⁹ are as defined in Table 1.

Table 1 provides 144 compounds of formula (I.k):

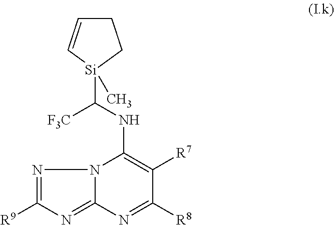

wherein R⁷, R⁸ and R⁹ are as defined in Table 1.

Table 1 provides 144 compounds of formula (I.l):

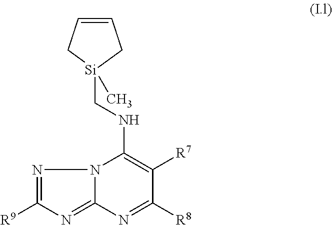

wherein R⁷, R⁸ and R⁹ are as defined in Table 1.

Table 1 provides 144 compounds of formula (I.m):

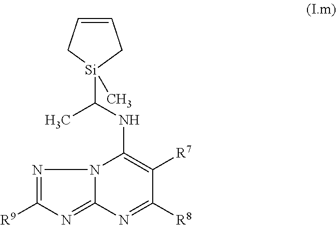

wherein R⁷, R⁸ and R⁹ are as defined in Table 1.

Table 1 provides 144 compounds of formula (I.n):

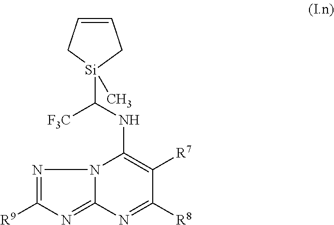

wherein R⁷, R⁸ and R⁹ are as defined in Table 1.

Table 1 provides 144 compounds of formula (I.o):

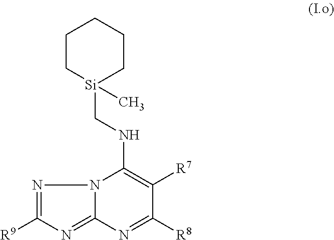

wherein R⁷, R⁸ and R⁹ are as defined in Table 1.

Table 1 provides 144 compounds of formula (I.p):

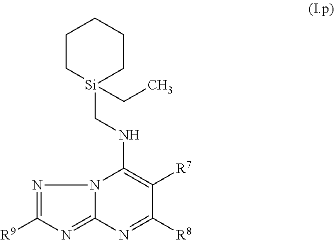

wherein R⁷, R⁸ and R⁹ are as defined in Table 1.

Table 1 provides 144 compounds of formula (I.q):

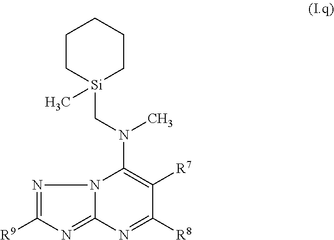

wherein R⁷, R⁸ and R⁹ are as defined in Table 1.

Table 1 provides 144 compounds of formula (I.r):

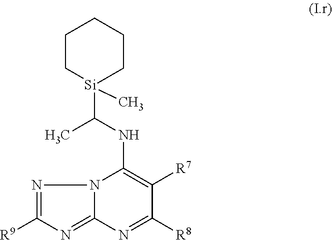

wherein R⁷, R⁸ and R⁹ are as defined in Table 1.

Table 1 provides 144 compounds of formula (I.s):

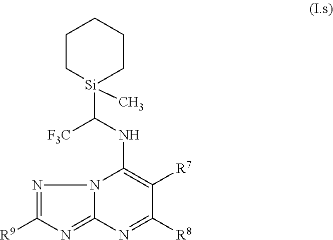

wherein R⁷, R⁸ and R⁹ are as defined in Table 1.

Table 1 provides 144 compounds of formula (I.t):

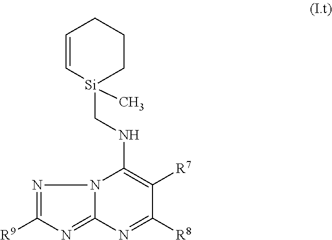

wherein R⁷, R⁸ and R⁹ are as defined in Table 1.

Table 1 provides 144 compounds of formula (I.u):

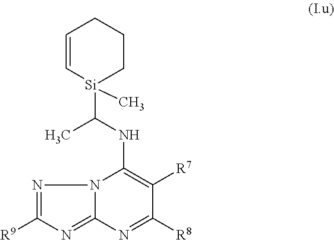

wherein R⁷, R⁸ and R⁹ are as defined in Table 1.

Table 1 provides 144 compounds of formula (I.v):

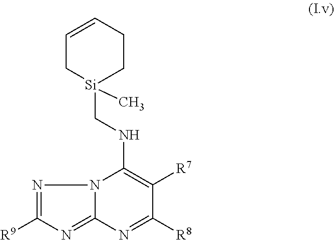

wherein R⁷, R⁸ and R⁹ are as defined in Table 1.

Table 1 provides 144 compounds of formula (I.w):

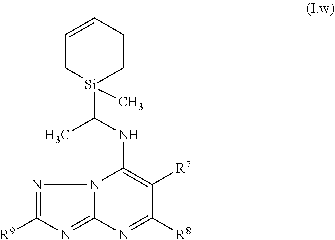

wherein R⁷, R⁸ and R⁹ are as defined in Table 1.

Table 1 provides 144 compounds of formula (I.x):

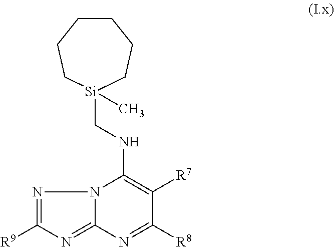

wherein R⁷, R⁸ and R⁹ are as defined in Table 1.

Table 1 provides 144 compounds of formula (I.y):

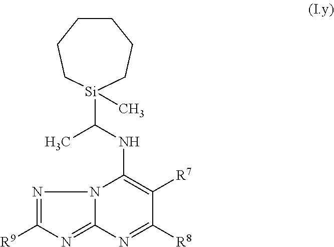

wherein R⁷, R⁸ and R⁹ are as defined in Table 1.

Table 1 provides 144 compounds of formula (I.z):

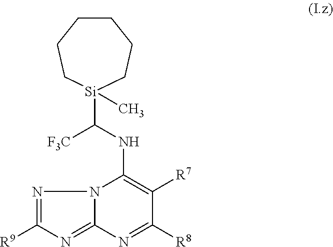

wherein R⁷, R⁸ and R⁹ are as defined in Table 1.

Throughout this description, temperatures are given in degrees Celsius; “NMR” means nuclear magnetic resonance spectrum; and “%” is percent by weight, unless corresponding concentrations are indicated in other units.

The following abbreviations are used throughout this description:
m.p.=melting point
s=singlet
d=doublet
t=triplet
m=multiplet
br=broad
dd=doublet of doubles
dt=doublet of triplets
q=quartet
ppm=parts per million

Table 2 shows selected melting point and selected NMR data, all with CDCl₃ as the solvent (unless otherwise stated, no attempt is made to list all characterising data in all cases) for compounds of Table 1

TABLE 2
Melting point and selected NMR data for compounds of Table 1

| | ¹H-NMR data | |
|---|---|---|
| Compound Number | (ppm/multiplicity/number of Hs) | m.p. (° C.) |
| I.d.081 | | 138-139 |
| I.o.081 | | 150-152 |

The compounds according to the present invention may be prepared according to the above-mentoned reaction schemes, in which, unless otherwise stated, the definition of each variable is as defined above for a compound of formula I.

### BIOLOGICAL EXAMPLES

sAlternaria solani/Tomato/Preventive (Action Aagainst Alternaria on Tomato)

4 weeks old tomato plants cv. Roter Gnom are treated with the formulated test compound in a spray chamber. Two days after application tomato plants are inoculated by spraying a spore suspension on the test plants. After an incubation period of 4 days at 22/18° C. and 95% r. h. in a greenhouse the disease incidence is assessed.

Compounds of formula I, in particular compound I.d.081, at 200 ppm inhibits fungal infestation in this test to a least 80%, while under the same conditions untreated control plants are infected by the phytopathogenic fungi to over 80%.

Botrytis cinerea/Tomato/Preventive (Action Against Botrytis on Tomato)

4 weeks old tomato plants cv. Roter Gnom are treated with the formulated test compound in a spray chamber. Two days after application tomato plants are inoculated by spraying a spore suspension on the test plants. After an incubation period of 3 days at 20° C. and 95% r. h. in a greenhouse the disease incidence is assessed.

Compounds of formula I, in particular compound I.d.081 at 200 ppm inhibits fungal infestation in this test to a least 80%, while under the same conditions untreated control plants are infected by the phytopathogenic fungi to over 80%.

Puccinia recondita/Wheat/Peventive (Action Against Brown Rust on Wheat)

1 week old wheat plants cv. Arina are treated with the formulated test compound in a spray chamber. One day after application wheat plants are inoculated by spraying a spore suspension (1×105 uredospores/ml) on the test plants. After an incubation period of 1 day at 20° C. and 95% r. h. plants are kept for 10 days 20° C./ 18° C. (day/night) and 60% r.h. in a greenhouse. The disease incidence is assessed 11 days after inoculation.

Compounds of formula I, in particular compound I.d.081 at 200 ppm inhibits fungal infestation in this test to a least 80%, while under the same conditions untreated control plants are infected by the phytopathogenic fungi to over 80%.

Magnaporthe grisea (Pyricularia oryzae)/Rice/Preventive (Action Against Rice Blast)

3 weeks old rice plants cv. Koshihikari are treated with the formulated test compound in a spray chamber. Two days after application rice plants are inoculated by spraying a spore suspension (1×10⁵ conidia/ml) on the test plants. After an incubation period of 6 days at 25° C. and 95% r. h. the disease incidence is assessed.

Compounds of formula I, in particular compound I.d.081 at 200 ppm inhibits fungal infestation in this test to a least 80%, while under the same conditions untreated control plants are infected by the phytopathogenic fungi to over 80%.

Pyrenophora teres (Helminthosporium teres)/Barley/Preventive (Action Against Net Blotch on Barley)

1-week-old barley plants cv. Regina are treated with the formulated test compound in a spray chamber. Two days after application barley plants are inoculated by spraying a spore suspension (2.6×10⁴ conidialmI) on the test plants. After an incubation period of 4 days at 20° C. and 95% r. h. the disease incidence is assessed.

Compounds of formula I, in particular compound I.d.081 at 200 ppm inhibits fungal infestation in this test to a least 80%, while under the same conditions untreated control plants are infected by the phytopathogenic fungi to over 80%.

Septoria tritici/Wheat/Preventive (Action Against Septoria Leaf Spot on Wheat)

2 weeks old wheat plants cv. Riband are treated with the formulated test compound in a spray chamber. One day after application wheat plants are inoculated by spraying a spore suspension (10⁶ conidia/ml) on the test plants. After an incubation period of 1 day at 22° C./21° C. and 95% r. h. plants are kept at 22° C./21° C. and 70% r.h. in a greenhouse. The disease incidence is assessed 16-18 days after inoculation.

Compounds of formula I, in particular compound I.d.081 at 200 ppm inhibits fungal infestation in this test to a least 80%, while under the same conditions untreated control plants are infected by the phytopathogenic fungi to over 80%.

Uncinula necator/Grape/Preventive (Action Against Powdery Mildew on Grape)

5 weeks old grape seedlings cv. Gutedel are treated with the formulated test compound in a spray chamber. One day after application grape plants are inoculated by shaking plants infected with grape powdery mildew above the test plants. After an incubation period of 7 days at 24/22° C. and 70% r. h. under a light regime of 14/10 h (light/dark) the disease incidence is assessed.

Compounds of formula I, in particular compounds I.d.081 and I.o.081 at 200 ppm inhibit fungal infestation in this test to a least 80%, while under the same conditions untreated control plants are infected by the phytopathogenic fungi to over 80%.

1. A compound of formula I 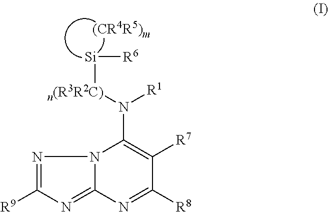
wherein R¹ is hydrogen, C₁-C₆alkyl, C₁-C₆haloalkyl, C₂-C₆alkenyl, C₂-C₆alkynyl or C(═O)C₁-C₆alkyl;
R² and R³, each independently of each other and independently of n when n is 2, 3 or 4, are hydrogen, halogen, C₁-C₆alkyl, C₁-C₆haloalkyl or C₁-C₆alkyloxy, or
R² and R³ are part of a C═C double bond when n is 2, 3 or 4, or
R² and R³, together with the carbon atom to which they are attached, form an optionally substituted three- to six-membered ring;
R⁴ and R⁵, each independently of each other and independently of m, are hydrogen, halogen, C₁-C₆alkyl, C₁-C₆haloalkyl or C₁-C₆alkyloxy, or
R⁴ and R⁵, together with the carbon atom to which they are attached, form a group C═O, C═S or C═CR¹⁰R¹¹, or
R⁴ and R⁵, together with the carbon atom to which they are attached, form an optionally substituted three- to six-membered spiro-attached ring, or
R⁴ and R⁵ are part of an endocyclic C═C double bond, or
R⁴ and R⁵, together with the carbon atoms to which they are attached, form an optionally substituted saturated or unsaturated annulated ring;
R⁶ is C₁-C₆alkyl, C₁-C₆haloalkyl, C₃-C₆cycloalkyl, C₂-C₆alkenyl, C₂-C₆alkynyl, halogen, cyano, hydroxy or C₁-C₆alkyloxy;
R⁷is optional substituted aryl or heteroaryl;
R⁸ is C₁-C₆alkyl, halogen or cyano;
R⁹ is hydrogen, mercapto or C₁-C₃alkylthio;
R¹⁰ and R¹¹ are, each independently of each other, hydrogen, halogen, C₁-C₆alkyl, C₁-C₃haloalkyl or C₁-C₆alkyloxy;
m is 3, 4, 5, or 6;
n is 1, 2, 3 or 4.

2. A compound of formula I according to claim 1 in free form.

3. A compound of formula I according to claim 1 in an agrochemically usable salt form.

4. A compound of formula I according to claim 1, wherein R¹ is hydrogen, C₁-C₆alkyl, C₂-C₆alkenyl, C₂-C₆alkynyl or C(═O)C₁-C₆alkyl;
R² and R³, each independently of each other and independently of n when n is 2, 3 or 4, are hydrogen, halogen, C₁-C₆alkyl, C₁-C₆haloalkyl or C₁-C₆alkyloxy;
R⁴ and R⁵, each independently of each other, are hydrogen, halogen, C₁-C₆alkyl, C₁-C₆haloalkyl or C₁-C₆alkyloxy;
R⁶ is C₁-C₆alkyl, C₁-C₆haloalkyl, C₃-C₆cycloalkyl, C₂-C₆alkenyl, C₂-C₆alkynyl, halogen, hydroxy or C₁-C₆alkyloxy;
R⁷ is an optionally substituted aryl or heteroaryl;
R⁸ is C₁-C₆alkyl, halogen or cyano;
R⁹ is hydrogen, mercapto or C₁-C₃alkylthio;
m is 3, 4, 5, or 6;
n is 1, 2, 3 or 4.

5. A compound of formula I according to claim 1, wherein
R¹ is hydrogen, C₂-C₆alkenyl or C₂-C₆alkynyl;
R² and R³, each independently of each other and independently of n when n is 2, 3 or 4, are hydrogen, halogen, C₁-C₆alkyl or C₁-C₆haloalkyl;
R⁴ and R⁵, each independently of each other, are hydrogen, halogen or C₁-C₆alkyl;
R⁶ is C₁-C₆alkyl, C₁-C₆haloalkyl or C₃-C₆cycloalkyl;
R⁷ is an optionally substituted aryl;
R⁸ is C₁-C₃alkyl or halogen;
R⁹ is hydrogen, mercapto or methylthio;
m is 3, 4 or 5;
n is 1, 2 or 3.

6. A compound of formula I according claim 1, wherein
R¹ is hydrogen or C₂-C₄alkynyl;
R² and R³, each independently of each other and independently of n when n is 2, 3 or 4, are hydrogen, C₁-C₃alkyl or C₁-C₃haloalkyl;
R⁴ and R⁵, each independently of each other, are hydrogen or C₁-C₃alkyl;
R⁶ is C₁-C₃alkyl or C₁-C₃haloalkyl;
R⁷ is phenyl substituted at least in one ortho-position with halogen;
R⁸ is chloro or fluoro;
R⁹ is hydrogen or mercapto;
m is 4 or 5;
n is 1 or 2.

7. A compound of formula I according to claim 1, wherein
R¹ is hydrogen;
R² and R³, each independently of each other and independently of n when n is 2, 3 or 4, are hydrogen, methyl or trifluoromethyl;
R⁴ and R⁵, each independently of each other, are hydrogen or methyl;
R⁶ is methyl or ethyl;
R⁷ is 2,4,6-trifluorophenyl or 2-chloro-6-fluorophenyl;
R⁸ is chloro;
R⁹ is hydrogen;
m is 4 or 5;
n is 1.

8. A process for the preparation of a compound of formula I defined in claim 1, which comprises reacting a compound of formula II, 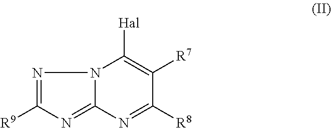
wherein R⁷, R⁸ and R⁹ are as defined for formula I and Hal is halogen, preferably fluorine, chlorine or bromine, with a compound of formula III, 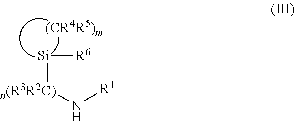
wherein R¹, R², R³, R⁴, R⁵, R⁶, m and n are as defined for formula I.

9. A fungicidal composition for controlling and protecting against phytopathogenic microorganisms, comprising as active ingredient at least one compound of formula I defined in claim 1, in free form or in agrochemically usable salt form, and at least one adjuvant.

10. A composition according to claim 9, which comprises at least one additional fungicidally active compound, prefarably selected from the group consisting of azoles, pyrimidinyl carbinoles, 2-amino-pyrimidines, morpholines, anilinopyrimidines, pyrroles, phenylamides, benzimidazoles, dicarboximides, carboxamides, strobilurines, dithiocarbamates, N-halomethylthiotetrahydrophthalimides, copper-compounds, nitrophenols, organo-phosphor-derivatives.

11. (canceled)

12. A method of controlling and preventing an infestation of crop plants and non-living materials by phytopathogenic or spoilage microorganisms or organisms potentially harmful to man, which comprises the application of a compound of formula I defined in claim 1 as active ingredient to the plant, to parts of the plants or to the locus thereof or to any part of the non-living materials.

13. A method according to claim 12, wherein the phytopathogenic microorganisms are fungal organisms.
